(19) United States
(12) Patent Application Publication
(10) Pub. No.: US 2008/0271378 A1
(43) Pub. Date: Nov. 6, 2008

(54) Louvered shutters with side-mounted tilt control

(76) Inventors: Hoan Kim Le, Cypress, TX (US); Lam Thanh Dang, Cypress, TX (US)

Correspondence Address: Michael L. Parks;Parks & Associates, PLLC, Suite 101, 3131 W. Alabama, Houston, TX, 77098, US

(21) Appl. No.: 11/799,831

(22) Filed: May 3, 2007

(51) Int. Cl. E06B 7/086

(52) U.S. Cl. 49/89.1

(57) ABSTRACT

A louvered shutter assembled from pre-finished parts using axle pins for louver rotation and pin members mounted in the louvers distal of the axle pins for connection to tilt bar by a snap together connection and for transmitting force to inducement rotational in the louvers and the tilt bar being shaped to pass between the shutter frame and the louvers for substantial flush relationship in closed position and allowing clear view through the louvers in their open position.

### FIELD OF THE INVENTION

This invention relates to a louvered shutter made from pre-finished pieces, having rotatable louvers, which can be assembled and do not require finished touch up after they are assembled. These pre-finished shutters also have a tilt bar mounted to the end surface of each louver for causing rotation of the louvers mounted in the shutter frame and being shaped for passing between the shutter frame and the end surfaces of the rotatable louvers for bringing the tilt bar to substantially flush relationship with the shutter in the closed position and for allowing unobstructed view through the louvers in the shutter in the open position. Also, this invention provides pre-finished components which have interlocking relationships with other components and fasteners for rapidly fastening the components into an operational pre-finished shutter, of high quality, having rotatable louvers.

### BACKGROUND OF THE INVENTION

The louvered shutter process of manufacturing and assembling them has historically comprised using staples, dowels, screws, and other elements for their assembly. After they were assembled, the louvered shutters were then either stained or painted for a finished product. Some louvered shutters have been pre-finished and then assembled, but then required touch up of the finish because the assembly process damaged the pre-finished parts during assembly. Some of the louvered shutters had tilt bar controls for rotation of the louvers mounted on the center leading edge of the louvers for inducing rotation. These tilt bars mounted on the leading edge of the louvers almost always caused damage to the finish of the louver or tilt bar when the brads were inserted into the leading edge of the louver and/or tilt bar.

Various pre-finished louvered shutters have attempted to overcome these defects and damage caused to pre-finished shutters in their final assembly process in various ways. Some louvered shutters have attempted to eliminate the damage problem during assembly by providing louver end caps or slotted tray frameworks into which a louver is mounted. These end caps or slotted trays were mounted into the shutter frames which created a complete movable framework for allowing rotation of the louvers because the tilt bar was part of the end caps or slotted trays framework into which the louvers were mounted for rotation of the louvers. These end caps or slotted trays attempted to allow assembly of the pre-finished parts with minimal damage to the parts during their assembly. However these end caps or slotted trays which held the louvers did not hold these louvers in place sufficiently unless they were held tightly enough to damage the pre-finished louvers upon insertion. These end caps or slotted trays formed a complete assembly on both sides of a shutter frame into which each individual louver had to be mounted into the end caps or slotted trays on both sides of the shutter frames after the movable framework of the end caps and slide trays were installed and this created alignment problems.

The prior art also had the problem of holding accurate alignment of the louvers because it used many parts for assembly. This made it easy to misalign the louvers or allowed them to become misaligned after they were installed. Further, in the case of louvers held by end caps or slotted trays over time the louvers became loose and would fall out or simply become misaligned which would jam the whole framework and prevent the louvers from operating after installation.

Further many of the prior art louvered shutters had the tilt bar mounted in the middle of the louvers along the leading edge, which while making it easy to adjust be the shutter, it was unsightly and blocked the vision and light coming through the center of the louvered shutter when the louver shutters were rotated into an open position.

Yet a further problem with the prior art pre-finished shutters was that they required many different pieces and sizes of parts for their assembly and this took up valuable time and increased the cost of fabricating the shutters prior to installation.

Also, some of the prior art devices used fasteners such as nails, brads, or other fasteners to mount the louvered shutters for rotation. These fasteners would cause the louvers to split or chip requiring the whole shutter and framework to be taken apart in the process for reassembly from the start.

While many of the prior art louvered shutters were utilized indoors in air-conditioned environments, some were used outdoors and in moisture environments indoors in the southern United States, so many of the prior art louvered shutters experienced corrosion of their parts. This was especially true of louvered shutters which were not pre-finished prior to assembly and/or had to be touched up after they were assembled.

As the prior art louvered shutters required considerable more parts and refinishing, they had more labor costs associated with the process of putting them together as a finished product. Also because of the increased number of parts, there was considerably more waste of parts and increased cost of the finished product.

### OBJECTS OF THE INVENTION

The object of this invention is to provide a louvered shutter with a high quality finish which is assembled from pre-finished parts and does not require touch up of the finish because this invention uses simplified parts which are easily assembled without damaging the parts during assembly.

As another object of this invention, is that it allows the pre-finish parts to be mounted in the shutter frame for movement of the shutters by the tilt bar without the use of end caps or slotted tray frameworks, into which the louvers are mounted. This invention completely eliminates any movable framework which is mounted independently to the shutter frame. Further by not having the movable framework there is no damage to the individual louvers as they are mounted to the frame.

It is a further object of this invention to provide accurate alignment of the louvers using a minimum amount of parts which allows for much easier alignment and less chance for misalignment of the louvers. Further, this invention eliminates the need for end caps or slotted trays to hold the louvers and therefore the louvers are not likely to be loose and fallout or become misaligned with future use and they are less likely to jam the louvers in the frames.

It is a further object of this invention that the tilt bar be mounted on the side of the louvers, between the louvers and the frame, which does not block the vision and light coming through the center of the louver shutter when the louver shutter is rotated into an open position. Also by being on the side of the louvers, the tilt bar is very unobtrusive.

Yet a further object of this invention using pre-finish shutters is that it does not require many different pieces and sizes of parts for their assembly and different sized louver shutters can be assembled using the same parts which are interchangeable. Also the assembly is very time efficient and reduces the cost of fabricating the louver shutters.

It is also a further object of this invention to eliminate the need for brads, nails and rely upon the pre-fabrication of the pre-finished parts created with interlocking relationships and pre-fabricated holes for receiving fasteners which eliminates splitting and chipping and allows for elimination of any need for reassembly from the beginning, because it creates a one pass assembly process of the louvered shutters.

Yet another object of this invention is to provide louvered shutters which may be utilized in outdoor environments and in moisture rich environments indoors in the southern part of United States without rust or corrosion developing because these louvered shutters and parts for their assembly use corrosion resistant parts and do not require refinish or touch up of these louvered shutters after assembly of the louvered shutters.

Yet further and additional benefits and improvement of the invention will be appreciated by others skilled in the art and those advantages and benefits of the invention will become apparent to those skilled in the art upon a reading and understanding of the following detailed description.

### BRIEF DESCRIPTION OF THE DRAWINGS

This invention may be practiced in certain other physical forms and arrangements of the parts herein described, but at least one preferred embodiment of which will be described in detail in the specification and illustrated in the accompanying drawings which form a part hereof.

FIG. 1 is a perspective view of the louvered shutter of this invention fully assembled and showing the louvers of the louvered shutters in an open position with the tilt bar attached to one end surface of the rotatable louvers distal from louvers axis for rotation, and a pair of spreaders and a pair of stiles in interlocking relationship and pre-fabricated holes for fasteners, to fasten the louvered shutter into a frame.

FIG. 2 is a perspective view of FIG. 1, showing the louvers of the louvered shutters in a closed position.

FIG. 3 is an exploded perspective view of the louvered shutter of this invention showing the rotatable louvers, axial pins mounted in the louvers on their end surfaces for creation of an axle for rotation of the louvers upon mounting the louvers in the frame, pin members mounted in one end of the rotatable louvers for mounting to a tilt bar, to be used for transmitting force for rotation of the rotatable louvers mounted in the frame and a pair of spreaders and pair of stiles fabricated for interlocking relationship and pre-drilled holes for receiving fasteners to fasten the shutter into a completed shutter.

FIG. 4 is an exploded perspective view of the end surface of a rotatable louver and the tilt bar showing one axial pin fix mounted into the end surface of the rotatable louver to create an axle for rotation of the rotatable louver and the other end for rotational mounting in stiles of the louvered shutter, and a pin with one end mounted in the end of the louver distal from the one axial pin and the other end of the pin for being mounted to the tilt bar for transmitting force for the rotation of the louvers in the shutter frame.

FIG. 5 is a perspective view of FIG. 4.

FIG. 6 is a side view of the end surfaces of a rotatable louvers and the tilt bar showing one of the axial pins fix mounted into the end surfaces of the rotatable louvers to create an axle for rotation of the rotatable louvers and the other ends for rotational mounting in stiles of the louvered shutter, and a pin with an end mounted in the end of the louver distal from the one axial pin and the other end of the pin for being mounted to the tilt bar for transmitting force for the rotation of the louvers in the shutter frame with the louver shutters in an open position.

FIG. 7 is a side view of the end surfaces of a rotatable louvers and the tilt bar showing one of the axial pins fix mounted into the end surfaces of the rotatable louvers to create an axle for rotation of the rotatable louvers and the other end for rotational mounting in stiles of the louvered shutter, and a pin with an end mounted in the end of the louver distal from the one axial pin and the other end of the pin for being mounted to the tilt bar for transmitting force for the rotation of the louvers in the shutter frame with the louver shutters in a closed position.

FIG. 8 is a cross-sectional view of a stile showing the pre-fabricated member for interlocking relationship with a spreader, not shown and a recessed surface to receive the strip member for mounting it to the stile.

FIG. 9 is a cross-sectional view of a strip member showing a pair of flexible elements being flexed inward upon mounting the strip member to a stile and flexed outwardly for locking engagement with a stile member upon final insertion in to the stile.

FIG. 10 is a side and partial cross-sectional view of a pinhead member, which would be inserted into in the end of a louver distal from the one axial pin, not shown, and the other end forming a male member having a head for snap together fitting with a female aperture member of the tilt bar for allowing rotation within the female member after insertion of the male pinhead member about a camming surface.

FIG. 11 is an exploded perspective view of the stile and strip member showing the relationship there between.

FIG. 12 is a perspective view of the stile and strip member showing them mounted together.

FIG. 13 is a cross-sectional view of a strip member showing its pair of flexible elements for being flexed inward on mounting the strip to the stiles and flexed outwardly for locking engagement with the stile upon insertion into the stile for locking engagement with each other.

### DESCRIPTION OF THE PREFERRED EMBODIMENTS

The purpose of this invention is for providing a high quality louvered shutter which can be made from pre-finished parts into a finished shutter using some parts that are interchangeable and without having to refinish the louvered shutter after its assembly. This louvered shutter invention provides ease of operation and reliability of use for many years because of its component elements used in its assembly process. This invention also allows the formation of louvered shutters that have few moving parts and have a tilt control bar for movement of the louvered shutters located off center of the louvers for allowing full view through the louvers when the louvered shutter is in its open position.

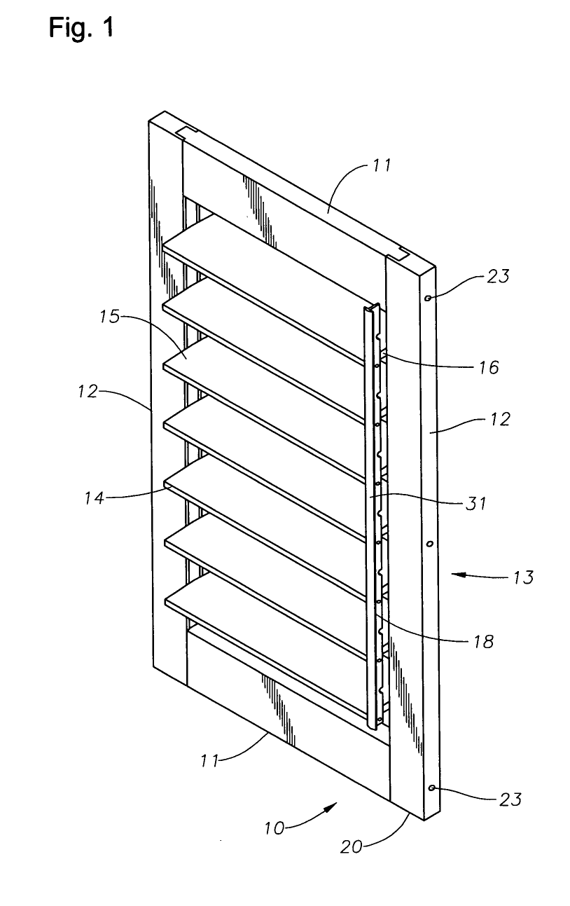

Referring now to FIG. 1, one embodiment of this louvered shutter used in this invention is generally shown at reference numeral 10. This embodiment of the louvered shutter 10 is generally formed from a pair of spreaders 11 mounted between a pair of stiles 12 for forming a frame 13 into which are mounted rotatable louvers 14. The rotatable louvers 14 are composed of two substantially flat surfaces 15 and two end surfaces 16. The rotatable louvers 14 are mounted by axial pins 17 (not shown in FIG. 1) in the two end surfaces 16 of the rotatable louvers 14. A tilt bar 18 is connected to rotatable louvers 14 at a pin member 19 mounted in one end surface 16 of the rotatable louvers 14 sufficiently distal from the axial pin 17 for transmitting force sufficient to allow inducement of axial rotation of rotatable louvers 14 and for controlling the rotation movement of the rotatable louvers 14 from a full open position to a full closed position and for positions in between.

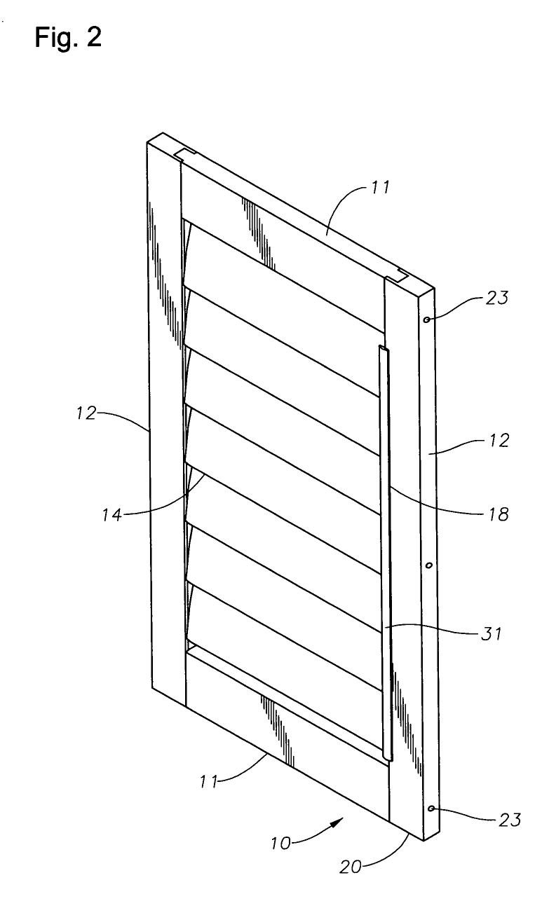

Further, by referring to FIG. 1, it can be seen that the tilt bar 18 is mounted to one of the two end surfaces 16 of the rotatable louvers 14 next to one of the pair of stiles 11 for allowing full view through the rotatable louver 14 of the louvered shutter 10 in an open position of the rotatable louvers 14 of the louvered shutter 10. Then by referring to FIG. 2, it can be seen that the tilt bar 18 is further mounted to one of the two end surfaces 16 of the rotatable louvers 14 next to one of the pair of stiles 11 for having a portion of the tilt bar 18 pass between the rotatable louvers 14 and the one of a pair of stiles 12 for allowing the tilt bar 18 to come to a substantially flush relationship with the stile 12 and the closed rotatable louvers 14.

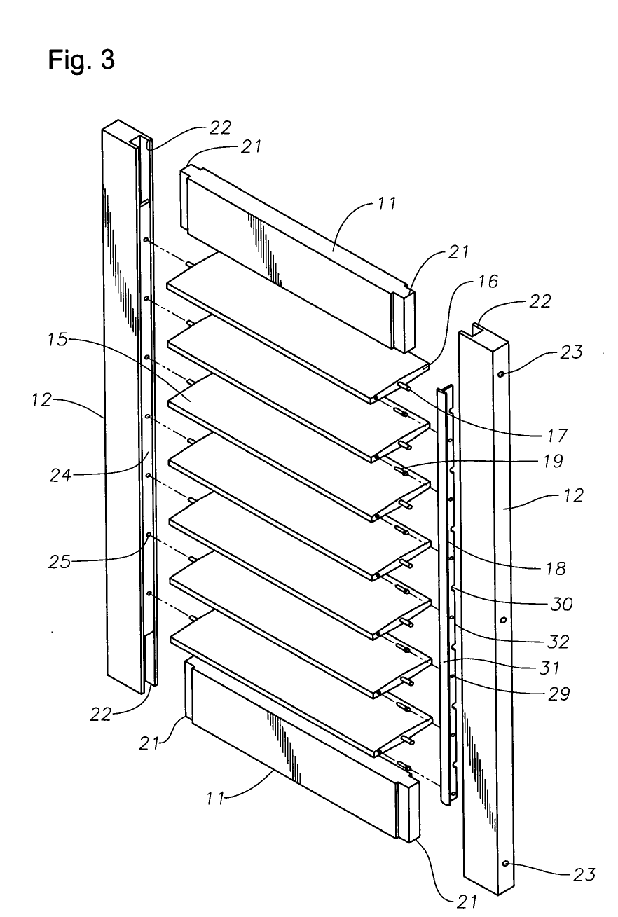

From FIG. 3, it can be seen generally how this louvered shutter 10 is formed into a shutter frame 20 by the pair of spreaders 11 and the pair of stiles 12 being fabricated for interlocking relationships at their ends 21 for the pair of spreaders 11 for mating with the fabricated interlocking sides 22 for the pair of stiles 12. To allow rapid and damage free assembly of these pre-finished parts pre-drilled holes 23 are formed in the stiles 12 at the point where ends 21 of fabricated interlocking of the spreaders 11 are located and fasteners (not shown) would be inserted too draw the pair of spreaders 11 and stiles 12 together. All this occurring without damage to, or requiring any touch up or refinishing, the pre-finished stiles 12 and spreaders 11. Also from FIG. 3 it can be seen a strip 24, having pre drilled holes 25, for mounting the rotatable louvers 14 is mounted along the sides 22 of the pair of stiles 12, and positioned between the ends 21 of the pair of spreaders 11 along the sides 22 of the pair of stiles 12 for even and accurate alignment of the pre-drilled holes 25 into which the at least two axial pins 17 for mounting the rotatable louvers 14 would be inserted. These strips 24, which are pre-finished, once aligned assure that the rotatable louvers 14 will be perfectly aligned and there will be no damage to the pre-finished rotatable louvers 14 upon assembly.

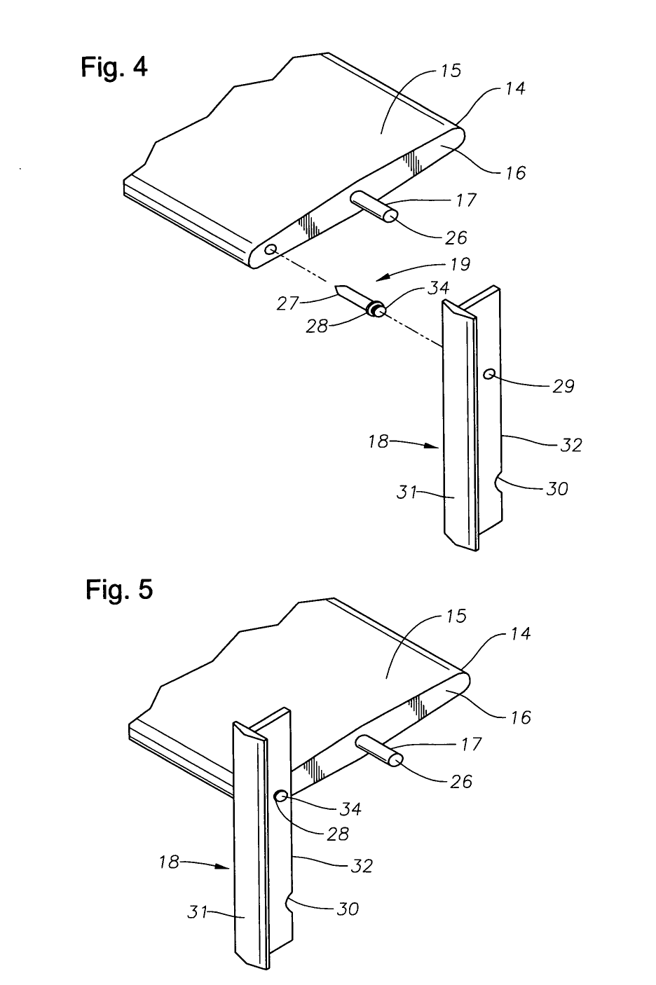

Referring to FIG. 4 and FIG. 5, it can be seen that the pre-finished rotatable louver 14 has an axial pin 17 with one end (not shown) of the axial pin 17 mounted in the rotatable louver 14 on its end surface 16 and the other end 26 free for mounting into the pre-drilled holes 25 of the strip member 24 to allow free rotation of the rotatable louver 14. These axial pins 17 can be used on many different sized louvers and thus provides a universal part, which reduces inventory costs. Also mounted into the rotatable louver 14 in its end surface 16 is a pin member 19, which is located distal from the axial pin 17, and has one end 27 for mounting to the rotatable louver 14, as shown in FIG. 4, and its other end 28 available for connection with the tilt bar 18. FIG. 4 is an exploded view, showing the dynamic exploded relationship of connection between pin member 34, rotatable louver 14, and tilt bar 18. FIG. 5 shows these elements fully assembled. The other end 28 of pin member 19, as shown also in FIG. 10 is connected to tilt bar 18 by insertion into an aperture 29 in the tilt bar 18 which allows rotation about the other end 34 of the pin member 19 within the aperture 29 of the tilt bar 18. As those skilled in the art will appreciate the fact that pin member 19 is distally located from axial pin 17 and free to rotate about tilt bar 18, apertature 29 allows movement by the tilt bar 18 to induce axial rotation of the rotatable louvers 14 by transmitting force sufficient for rotation of the rotatable louvers 14 mounted in the shutter frame 10.

As shown in FIG. 10, for one embodiment, the aperture 29 has a recess 33 for providing a camming surface to allow easy rotation of the pin member 19. The aperture 29 allows pin member 19, which has a head 34 to pass through for forming a snap together fitting upon receiving pin member 19 on its surface 28. This snap together fitting is important because it requires no tools or fasteners be used and the final snapping together of the tilt bar 18 with its connection to the pre-finished rotatable louvers 14 and eliminates the possibility of damage to the pre-finished rotatable louvers 14 during the assembly process. Further the snap together fitting provides good positive connection between the tilt bar 18 and the rotatable louvers 14 for smooth movement of the rotatable louvers 14 in their operation in the louvered shutter 10. As those skilled in the art will appreciate this snap together fitting eliminates one of the most common failure points for louvered shutters, the tile bar breaking lose from the rotatable louvers.

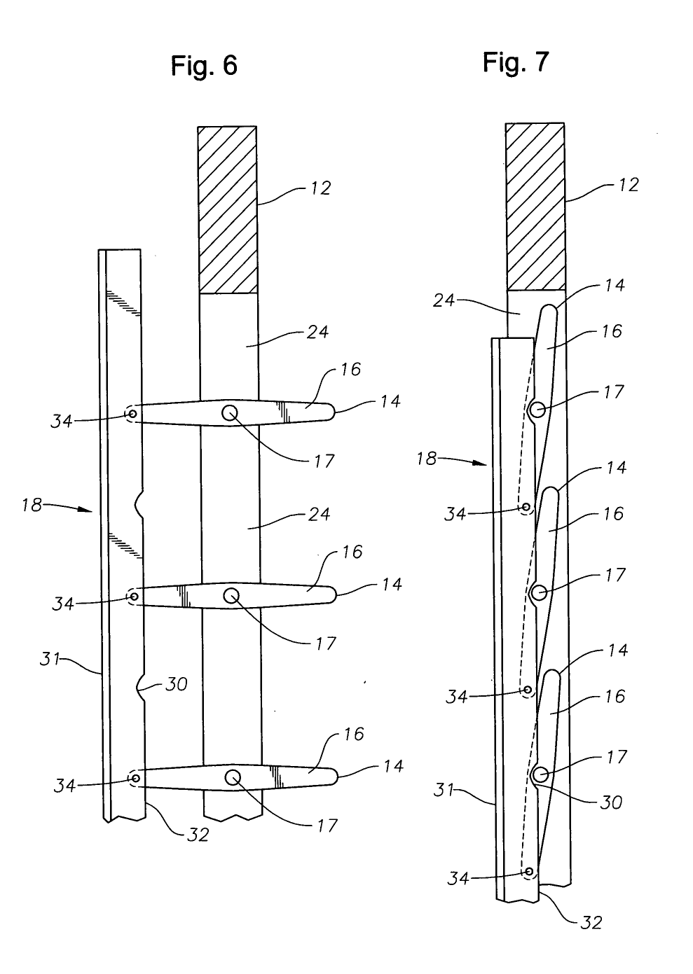

As can be seen in FIG. 6 and FIG. 7, these transmitted forces sufficient for rotation of the rotatable louvers 14 mounted in the shutter frame 10, causes all the rotatable louvers 14 to open or close in perfect alignment. The tilt bar 18 as shown in FIG. 4, FIG. 5, and FIG. 10, is formed into a T-shape with a crossing piece 31 and vertical part 32. The vertical part 32 having a shape for passing between a portion of stile 12 and the end surface 16 of rotatable louver 14 to bring the tilt bar 18 to a substantially flush relationship with the rotatable louvers 14 and stile 12 when the rotatable louvers 14 are in their closed position, as shown also in FIG. 6 and FIG. 7. The tilt bar 18 as shown in FIG. 6 and FIG. 7 is further provided on its vertical part 32 with recessed cut outs 30, which when the tilt bar 18 has been moved to close the rotatable louvers 14, the recessed cut outs 30 allow they vertical part 32 of tilt bar 18 to pass over the axial pin 17 to bring the tilt bar 18 to substantially flush the relationship with the rotatable louvers 14 and stile 12.

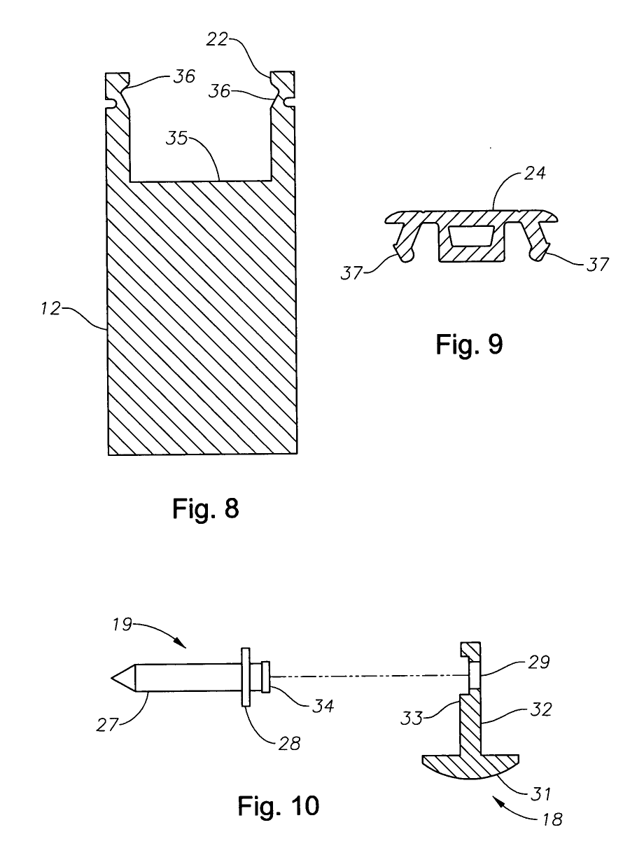

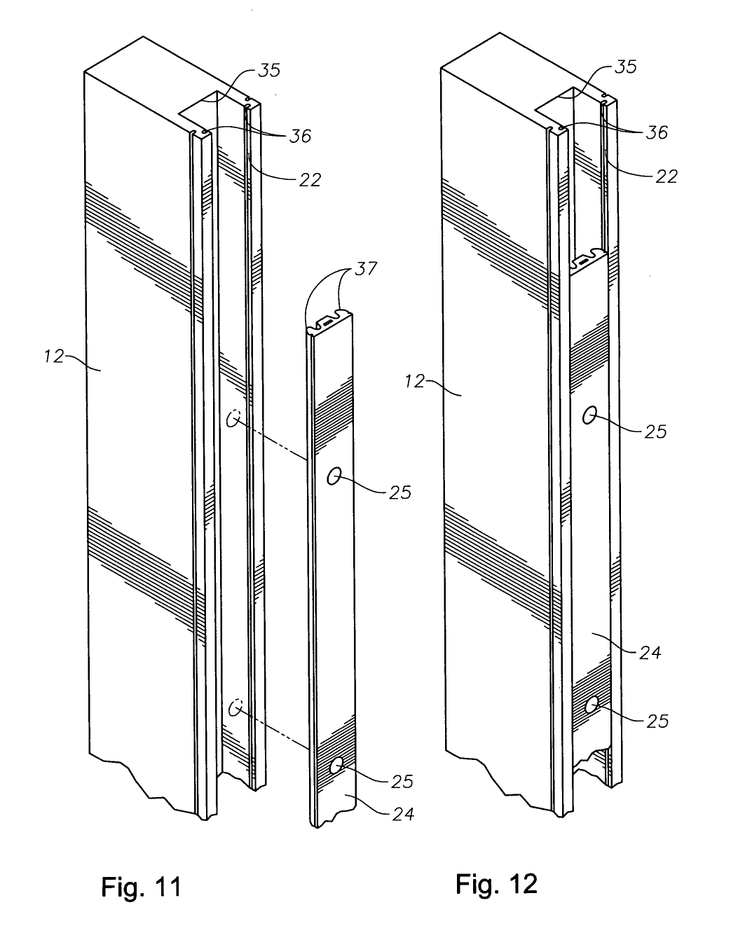

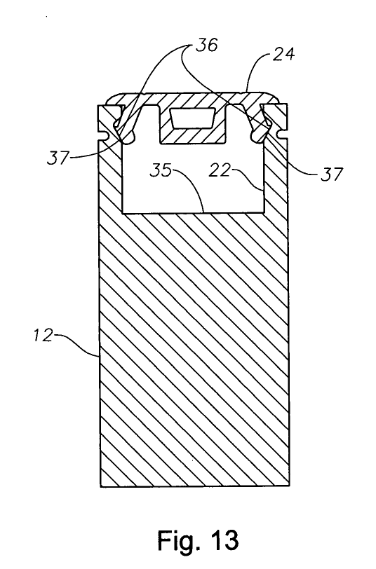

The strip 24 and stile 12 relationship formation in this invention is important because it eliminates the use of tools which may damage the pre-finished parts and ultimately control the alignment of the rotatable louvers 14 in the shutter frame 10 by perfectly aligning the pre-drilled holes 25 in the strip 24 which receives the two axial pins 17 of each rotatable louver 14. By referring to FIG. 11 and FIG. 12, and as previously discussed, the strip 24 inserts into the stile 12 along the sides 22 of stile 12. However, as shown in FIG. 11 and FIG. 12, it can be seen that they fit together to achieve a smooth and clean finish appearance. This interface is achieved by the strip 24 being inserted into the sides 22 at the pre-fabricated interlocking channel 35, which runs along sides 22 of the stile 12 and has a recessed surface 36 there along to receive the strip 24, as best shown in FIG. 8. The strip 24, has flexible members 37 as shown in FIG. 9 which are flexed inward upon insertion into the stile 12 along its locking channel 35 and then the flexible members 37 flexes outward into a recessed surface 36 of locking channel 35 for engagement to hold the strip 24 in the stile 12 to form a smooth and clean finish appearance as shown in FIG. 13. Perfect alignment of the pre-drilled holes 25 in the strips 24 for aligning the rotatable louvers 14 is achieved by placing the strips 24 at the same location on each stile 12 along its sides 22 because the pre-drilled holes 25 are located exactly the same on each strip 24. This use of a pre-finished strip 24 with a pre-finished stile and the flexible connection there between eliminates the possibility of damage to the pre-finished surfaces and guarantees alignment of the rotatable louvers 14.

While the preferred embodiments of the invention and the methods of their use have been described for the pre-finished louvered shutters of this invention, it will be appreciated that other embodiments and methods may be used without departing from the spirit of this invention and that it may be used with any type louvered shutter using various sizes and types of rotatable louvered shutters.

That claimed is:

1. A louvered shutter of wood or composite fiberboard for allowing assembly from pre-finished elements having at least one tilt bar control for flush closure with said shutter in closed position and for allowing unobstructed full view through said louvers of said shutter in opening positions comprising;
a. rotatable louvers having substantially two flat surfaces and two end surfaces for being mounted in said shutter frame,
b. means mounted to said two end surfaces of said rotatable louvers for axial rotation of said rotatable louver and for mounting said rotatable louvers for axial rotation in said shutter frame,
c. means mounted to at least one of said end surfaces of said rotatable louvers sufficiently distal from said means mounted to said two end surfaces for inducement of axial rotation of said rotatable louver, and
d. at least one tilt bar means mounted to said means mounted to at least one of said end surfaces of said rotatable louvers sufficiently distal from said means mounted for inducement of axial rotation of said rotatable louvers for transmitting force sufficient for causing rotation of said rotatable louvers mounted in said shutter frame and having a shape for passing between a portion of said shutter frame and a portion of said end surfaces of said rotatable louvers for bringing said tilt bar to substantially flush relationship with said shutter frame in closed position and for allowing unobstructed full view through said louvers in opening positions.

2. A louvered shutter of wood or composite fiberboard for allowing assembly from pre-finished elements of claim 1 wherein said shutter frame further comprises;
a. a pair of spreaders which are fabricated for interlocking relationship and having pre-drilled holes,
b. a pair of stiles which are fabricated for interlocking relationship with said pair of spreaders and having pre-drilled holes, and
c. fastener means for insertion into said pre-drilled holes in said stiles and spreaders for fastening said pair of stiles and said pair of spreaders for forming said shutter frame.

3. A louvered shutter of wood or composite fiberboard for allowing assembly from pre-finished elements of claim 2 wherein said means mounted to said two end surfaces for rotation of said rotatable louvers further comprises,
a. at least two axial pins means having one end of said axial pin means for fixed mounting in one of both of said two end surfaces of said rotatable louvers for axial rotation of said rotatable louvers and said other end of said axial pin means for rotational mounting at pre-determined positions in said stiles.

4. A louvered shutter of wood or composite fiberboard for allowing assembly from pre-finished elements of claim 3 further comprising,
a. strip means having pre-drilled holes at predetermined positions for receiving said other end of said axial pin means for rotation in said pre-drilled holes and aligning said rotateable louver in parallel alignment for mounting to said pair of stiles.

5. A louvered shutter of wood or composite fiberboard for allowing assembly from pre-finished elements of claim 4 wherein said strip means having holes at predetermined positions for receiving said other end of said axial pin means for rotation further comprises;
a. fabricated surface means of said strip means for interlocking relationship with said pair of stiles between said interlocking relationship with said pair of spreaders along said pair of stiles.

6. A louvered shutter of wood or composite fiberboard for allowing assembly from pre-finished elements of claim 5 wherein fabricated surface means of said strip means for interlocking relationship further comprises,
a. a pair of flexible means located along said strip means for being flexed inward upon mounting said strip means to said pair of stiles and flexed outward for locking engagement of said strip means to said pair of stiles upon full mounting said strip means to said pair of stiles.

7. A louvered shutter of wood or composite fiberboard for allowing assembly from pre-finished elements of claim 6 wherein said means mounted to at least one of said end surfaces of said rotatable louvers sufficiently distal from said means mounted to said two end surfaces for axial rotation of said rotatable louver further comprises,
a. pin means having one end of said pin mounted in said end of said rotatable louvers and the other end of said pin means for mounting to said at least one tilt bar means for transmitting force sufficient for rotation of said rotatable louvers mounted in said shutter frame.

8. A louvered shutter of wood or composite fiberboard for allowing assembly from pre-finished elements of claim 7 wherein said at least one tilt bar means mounted to said means mounted to at least one of said end surfaces of said rotatable louvers sufficiently distal from said means mounted for inducement of axial rotation of said rotatable louvers for transmitting force sufficient for causing rotation of said rotatable louvers further comprises;
a. a vertical part having a width sufficient for passing between a portion of said shutter frame and a portion of said end surfaces of said rotatable louvers and having a depth sufficient for providing rigidity through its whole length for transmitting sufficient force evenly for rotation of said rotatable louvers and cut out sections therein sufficiently deep for allowing said tilt bar to pass over said means mounted to said two end surfaces of said rotatable louvers for axial rotation of said rotatable louver and for mounting said rotatable louvers for axial rotation in said shutter frame for allowing said tilt bar to be in substantially flush relationship with said shutter frame in closed position, and
b. a top surface area member connected to said strip member wider than said vertical part for allowing ease of operation and for providing additional rigidity through its whole length for transmitting sufficient force evenly for rotation of said rotatable louvers.

9. A louvered shutter of wood or composite fiberboard for allowing assembly from pre-finished elements of claim 8 wherein said vertical part further comprises;
a. a series of attachment point means spaced along said at least one tilt bar means alternating with said cut outs sections to allow attachment to said means mounted to at least one of said end surfaces of said rotatable louvers sufficiently distal from said means mounted for axial rotation.

10. A louvered shutter of wood or composite fiberboard for allowing assembly from pre-finished elements of claim 9 where in said other end of said pin means for mounting to said at least one tilt bar means for transmitting force to said one pin means having one end of said pin mounted in said end of said rotateable louvers further comprises;
a. a male pinhead member having a brim for snap together fitting with said tilt bar, and having a camming surface for allowing rotation within said tilt bar after insertion.

11. A louvered shutter of wood or composite fiberboard for allowing assembly from pre-finished elements of claim 10 wherein said series of attachment points spaced along said at least one tilt bar means further comprises;
a. female aperture members for recovering a snap together fittings of said male pinhead member for allowing rotational movement between said tilt bar and said pinhead member for louver rotation in said shutter frame.
